(19) United States
(12) Patent Application Publication
(10) Pub. No.: US 2009/0058257 A1
(43) Pub. Date: Mar. 5, 2009

(54) ACTIVELY CONTROLLED DISTRIBUTED BACKLIGHT FOR A LIQUID CRYSTAL DISPLAY

(75) Inventors: Hao Li, Chandler, AZ (US); Kenneth Dean, Phoenix, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/846,366

(22) Filed: Aug. 28, 2007

(51) Int. Cl. H01J 1/62

(52) U.S. Cl. 313/496

(57) ABSTRACT

A liquid crystal display includes a field emission backlight (500) that eliminates the effects of backscatter electrons on spacers (532). The field emission backlight (500) includes an anode (530), a cathode (204) separated from the anode (530) by a first distance (403), and a plurality of electron emitters (504) disposed on the cathode (204). A plurality of spacers (532) separate the anode (530) and cathode (204) by a first distance (403) and are disposed a second distance (408) from the nearest electron emitters (504), wherein the second distance (408) is at least twice the magnitude of the first distance (403).

### FIELD

The present invention generally relates to displays for electronic devices and more particularly to an actively controlled distributed backlight for a liquid crystal display (LCD).

### BACKGROUND

The market for electronic devices having displays, for example, televisions, computer monitors, cell phones, personal digital assistants (PDA's), digital cameras, and music playback devices (MP3), is very competitive. Manufactures are constantly improving their product with each model in an attempt to cut costs and production requirements.

The display industry has grown rapidly in the last decade and consumers continue to demand higher quality, more power efficient display technology. Standard emissive LCDs require a high power illumination source or backlight behind the liquid crystal display panel. The liquid crystal then shutters this light to produce an image. A typical liquid crystal display transmits only about 2-5% of the light from the backlight. The rest is lost in the process. Consequently, the backlight must be 20 times brighter than the displayed image, which consumes a lot of power, if not most of the power of the display. Moreover, since the backlight is always on, black is only displayed by shuttering all the light from the backlight. In practice, this is difficult, and typical LCDs achieve a contrast ratio of 100 to 500 (vs. greater than 10,000 for CRTs). The poor contrast ratio is most readily noticeable in dark scenes in movies, and this is a common use case for larger-sized LCDs.

More recently, a method called dynamic backlighting has been demonstrated to reduce the LCD display power while substantially improving the picture quality. The backlight is divided into a low resolution matrix, and each area is addressed individually. The image brightness is determined by the backlight intensity and the LCD shutter ratio. For a bright object, the backlight is turned all the way on while the LCD shutter is also opened fully. For a dim object, the backlight is turned nearly off, and the aperture is closed. This substantially improves the dynamic range of the display, making it look much nicer. Since the average video scene is only 20% of full brightness, the backlight power can be reduced substantially.

Previous attempts at dynamic backlighting are lacking because traditional fluorescent backlights cannot switch on and off fast enough, and pay a big lifetime penalty when operated in this manner. Recently, LEDs have become a viable technical solution. LEDs have been constructed having backlight planes for 42″ LCD televisions, and demonstrated outstanding performance. However, with 2000 individually addressable LEDs, the backplane cost is quite high. Currently, the cost stands at several thousand dollars.

Accordingly, it is desirable to provide an actively controlled distributed backlight for an optical shutter display such as a liquid crystal display or a backlit electrowetting display. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is a cross section of a known liquid crystal pixel;

FIG. 2 is a perspective view of a portion of three emitter pads of a known field emission device;

FIG. 3 is a cross section taken along the line 3-3 of FIG. 2 and includes a portion of an anode positioned thereabove;

FIG. 4 is a perspective view of the field emission backlight in accordance with an exemplary embodiment;

FIG. 5 is a partial schematic view of the field emission backlight in accordance with an exemplary embodiment;

FIG. 6 is a partial cross section view of the field emission backlight positioned adjacent to an LCD in accordance with the exemplary embodiment;

### DETAILED DESCRIPTION

A liquid crystal display includes a field emission backlight that eliminates the effects of backscatter electrons on spacers. The field emission backlight includes an anode, a cathode, and a plurality of electron emitters disposed on the cathode. A plurality of spacers separate the anode and cathode by a first distance and are disposed a second distance from the nearest electron emitters, wherein the second distance is at least twice the magnitude of the first distance.

Field emission displays can modulate light with sub-millisecond response times, and they are also comparatively inexpensive light sources. This makes them desirable for backlight applications. An FED includes an anode, a cathode, and spacers that keep the anode and the cathode from collapsing under vacuum. Electrons emitted from the cathode strike cathodoluminescent phosphors on the anode to produce light. As a light source, cathodoluminescent phosphors are not as power efficient as other light sources such as fluorescent lights. However, the efficiency of cathodoluminescent phosphors increases sharply with electron energy and anode voltage. To compete with existing light sources, anode voltages exceeding 5 KV are required. Moreover, cathodoluminescent light sources are known to age as a function of the overall number of electrons hitting the phosphor. Achieving brightness with a high current and low anode voltage limits the lifetime of the phosphors, and correspondingly, of the backlight. For the lifetime issue, it is desirable to operate at high voltages (8-15 KV) and low currents. This is especially true for a backlight because it must produce 20 times more light than the phosphors of a CRT display due to the inefficient optical shutters like LCDs. This can be accomplished by using a higher duty cycle, which is feasible because the number of scan lines in an FED backlight is much smaller than in traditional field emission displays.

It is well known that under electron bombardment, spacers may charge up due to secondary electron emission from the spacer surface. Charged spacers significantly alter the local electric field and consequently alter the trajectories of the electrons around the spacer, resulting in “visible” spacers. In more serious cases, this charging leads to arcing and device destruction. The spacer technology for a typical field emission display holding off these voltages is difficult to implement, and would involve very leaky spacers and reliability problems (see U.S. Pat. No. 5,985,067), or extra discharging electronics (see U.S. Pat. No. 6,031,336).

During the operation of an FED, spacers are bombarded by both primary electrons (PEs) from the cathode and backscattered electrons (BSEs) from the anode. The most straightforward way to control spacer charging is to prevent spacers from being hit by these electrons. The divergence of PEs can be controlled to some extent by the design of cathode and/or through a focusing element. The control of BSEs on the other hand is much more difficult and almost impossible to eliminate. Disclosed herein is a backlight structure that produces a stable, highly efficient, high voltage device with no visual artifacts. This involves a specific anode-spacer-cathode configuration so that all electron sources are at least a distance of two times of the anode cathode gap away form any spacer surface.

Assume the voltage across the gap is P, and the gap is s, and electrons have a charge of q and mass of m. The incident velocity of the primary electrons is:

$$V = \sqrt{\frac{2 q P}{m}}$$

This is also the initial velocity of the BSE. There is no acceleration along the X direction and along the Y axis it is:

$$a = \frac{- q p}{m s}$$

The time for a BSE to come back to the anode can be calculated by setting Y to 0.

$$Y = {V}_{y} \cdot t + \frac{1}{2} a {t}^{2} = 0 \\ ⇒ t = - \frac{2 {V}_{y}}{a}$$

And the BSE landing position X on the anode is:

$$\begin{matrix}X = {V}_{x} \cdot t \\ = {V}_{x} \cdot ( \frac{- 2 {V}_{y}}{a} ) \\ = V cos α \cdot ( \frac{- 2 V sin α}{a} ) \\ = \frac{- {V}^{2} sin 2 α}{a} \\ = - \frac{2 q P}{m} sin 2 α / - \frac{q P}{m s} \\ = 2 \cdot s \cdot sin 2 α\end{matrix}$$

where α is the BSE launching angle, which varies from 0 to 90 degrees.

It is seen that the landing position has nothing to do with the voltage of the anode, or the electron charge or mass. The only relevant parameters are the anode-cathode gap and the launching angle. It reaches the maximum distance of 2 s at 45 degrees. Therefore, this BSE will not intercept a spacer surface that is at least 2 s away from the primary beam landing position. Considering the unique requirements of a backlight of relatively large pixel sizes, as well as the use of a diffuser, it is conceivable to place all spacers 2 s away from the nearest pixels, avoiding the potential charging problem caused by the BSEs. This is achieved by arranging specific anode and spacer layout combinations.

The following detailed description is merely exemplary in nature and is not intended to limit the invention or the application and uses of the invention. Furthermore, there is no intention to be bound by any theory presented in the preceding background or the following detailed description.

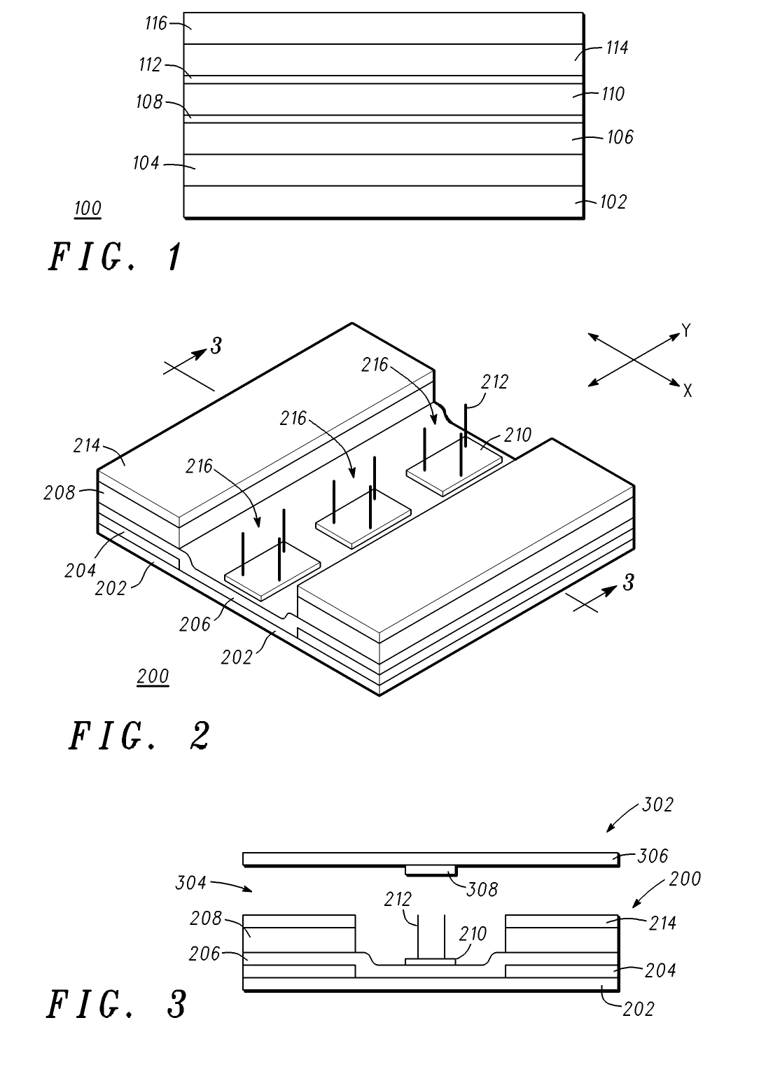

FIG. 1 is a partial cross section of a known LCD of a single pixel including a backlight 102. The backlight 102 in many known LCDs alternatively comprises a reflective surface. A horizontal filter film 104 is formed over the backlight 102 for blocking or allowing the light to pass. A substrate 106, typically glass, includes a first electrode 108. A layer 110 of liquid crystal molecules are disposed over the first electrode 108 and substrate 106. A second substrate 114 of a transparent material such as glass, having a second electrode 112 disposed thereon is formed over the layer 110. A vertical filter film 116 is formed over the second substrate 114. Though a single pixel is shown, it is understood an LCD comprises a plurality of pixels, formed by a matrix of orthogonal electrodes. An optional diffuser 103 may be formed between the backlight 102 and the filter film for providing a more even distribution of light.

The electrodes 108 and 112 in contact with the layer 110 of liquid crystal material are treated to align the liquid crystal molecules in a particular direction. In a twisted nematic device, the most common LCD, the surface alignment directions at the two electrodes 108 and 112 are perpendicular and the molecules arrange themselves in a helical structure, or twist. Light passing through one polarizing filter is rotated by the liquid crystal material, allowing it to pass through the second polarized filter. When a voltage is applied across the electrodes 108 and 112, a torque acts to align the liquid crystal molecules parallel to the electric field. The magnitude of the voltage determines the degree of alignment and the amount of light passing therethrough. A voltage of sufficient magnitude will completely untwist the liquid crystal molecules, thereby blocking the light.

Referring to FIG. 2, a field emission device 300 is provided for use as the active light source 104 of FIG. 1 in accordance with an exemplary embodiment. The field emission device 200 includes a cathode electrode 204 positioned on a substrate 202. A ballast resistive layer 206 is positioned between a dielectric layer 208 and the cathode electrode 204. A catalyst material 210 is positioned on the ballast resistive layer 206 for allowing higher quality growth of carbon nanotubes 212 thereon. A gate electrode 214 is positioned on the dielectric layer 208 for drawing electrons from the carbon nanotubes 212 in a manner known to those skilled in the art. The substrate 202 comprises glass; however, alternate materials, for example silicon, ceramic, metal, a semiconductor material, an organic material, or a combination thereof, are anticipated by this disclosure. Substrate 202 can include control electronics or other circuitry, which are not shown in this embodiment for simplicity. The cathode metal 204 may comprise any conductive layer, for example, a chrome/copper/chrome layer. The optional ballast resistor layer 206 of a semiconductor material is deposited over the cathode metal 204 and the substrate 202. A dielectric layer 208 is deposited over the ballast resistor 206 above the cathode metal 204 to provide spacing for the gate electrode 214. The gate electrode 214 comprises a metal, preferably molybdenum. The above layers and materials are formed by standard lithographic techniques known in the industry and as described above.

A catalyst 210 is formed on the ballast resistor 206, or in contact with the cathode 204 if the ballast resistor is not used. The catalyst material 210 comprises pads 216 (or pads) of carbon nanotubes 212. In FIG. 2, while three pads 216 are shown, it should be understood that many pads 216 are typically used. The catalyst 210 preferably comprises nickel, but could comprise any one of a number of other materials including cobalt, iron, and a transition metal or oxides and alloys thereof. The catalyst 210 may be formed by any process known in the industry, e.g., co-evaporation, co-sputtering, co-precipitation, wet chemical impregnation, adsorption, ion exchange in aqueous medium or solid state. One or more ancillary layers (not shown) for altering physical properties of the catalyst 210 optionally may be formed on the ballast resistor layer 206 and gate electrode 214 prior to forming the catalyst 212. Though only a few carbon nanotubes 212 are shown, it is understood that many thousands of carbon nanotubes 212 may be grown on each catalyst pad 210. Furthermore, it should also be understood that electron emitting devices, e.g., spindt tip, other than carbon nanotubes may be used.

FIG. 3 shows an anode 302 displaced from the cathode structure 200 (taken along line 3-3 in FIG. 2) by an evacuated region 304. The anode 302 comprises a transparent plate 306, which is typically made of glass. A plurality of islands 308 arranged typically in rows and columns across the anode 302 include deposits of a light emitting material, such as a cathodoluminescent material, or phosphor.

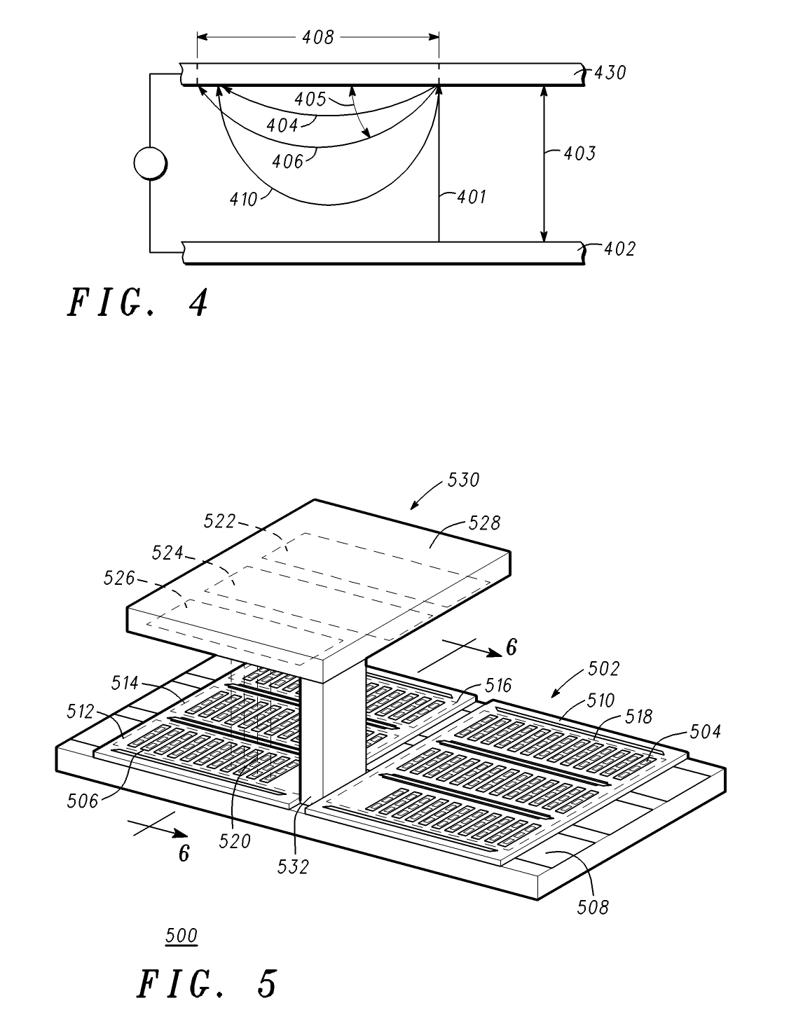

Referring to FIG. 4 and the equations presented above, when an incident beam of electrons 401 strikes the anode 430, the landing position of any backscattered electron beam on the anode is at most 2 S away from the incident beam 401, when the distance between the anode 430 and cathode 402 is S (represented by the arrow numbered 403). At a backscattered angle of 45 degrees (reference numeral 405), the backscattered beam of 406 reach a maximum distance of 2 S (represented by the arrow numbered 408). At any angle other than 45 degrees, the backscatter electrons 404, 410 will travel a distance of less than 2 S. Thus if a spacer is placed 2 S away from the primary incident beam, the backscattered electrons will not reach the spacer. The backscattered electrons may be backscattered again and reach the spacer through multiple backscattering. However, it will be at a much lower rate than the initial backscattering. This is because only a small portion of electrons (˜10%) will be backscattered and they travel to all directions not limited to the direction of the spacers. This leads to significantly less charging on the spacer surface and can be managed much easier.

A field emission device configured in an addressable matrix provides backlighting for an optical shutter display module resulting in a high efficiency and a low cost solution. In one embodiment, the field emission device contains regions that emit white light, and the optical shutter produces either a monochrome image, or a color image, by using laterally-disposed color filters. In another embodiment which is generally at least three times more power efficient, the backlight contains a matrix of primary colors (typically red, green, and blue). The backlight turns on the red screen, then green, then blue in a timed sequence and repeats (color sequential drive). The pixels of the optical shutter array do not need to be divided into color subpixels, allowing for a larger, more efficient aperture ratio.

In accordance with the exemplary embodiment and referring to FIG. 5, a schematic representation of the field emission device backlight 500 includes the cathode 502 having a plurality of emitter pads 504 formed within trenches 506 and over and uniquely coupled to each of the orthogonal column address lines 508 and row address lines 510. The emitter pads 504 are disposed as a plurality of sub-pixels 512, 514, 516, while a row of three sub-pixels define a pixel 518. The sub-pixels 512, 514, 516 are configured to provided electrons 520 to a phosphor corresponding to a different one of the three primary colors, for example, red, green, and blue phosphors 522, 524, 526 disposed within black surround layer (black matrix, for example ruthenium oxide) 528 on the anode 530 for providing red, green, and blue wavelengths, respectively (only a portion of the anode 530 is shown for clarity). By individually activating each subpixel 512, 514, 516, the resulting color can be varied anywhere within the color gamut triangle. The color gamut triangle is a standardized triangular-shaped chart used in the color display industry. The color gamut triangle is defined by each individual phosphor's color coordinates, and shows the color obtained by activating each primary color to a given output intensity. The grayscale intensity of each backlight subpixel can be controlled in the same manner as other field emission displays, through pulse width modulation, and amplitude modulation.

A spacer 532 is positioned between the cathode 502 and anode 530 and spaced a distance of 2 S from the nearest emitter pad 504, the importance of which is discussed above. The spacers 532 maintain a predetermined spacing of distance S between the anode 530 and the cathode structure 502, without interfering with the light emitting function of the backlight 500 and thereby defining an evacuation area 514.

After the spacers 532 are positioned in their desired location and the flat panel display backlight 500 is placed in a vacuum, a high voltage of 5,000 to 15,000 volts, for example, is applied between the anode 530 and the cathode 502. This positive voltage pulls electrons 520 from the emitter pads 504 toward the anode 530; Since the spacer is at least 2 s away from the emitter pads, few backscattered electrons reaches the spacer surface, resulting in little spacer charging, which is manageable by a variety of spacer charge control methods.

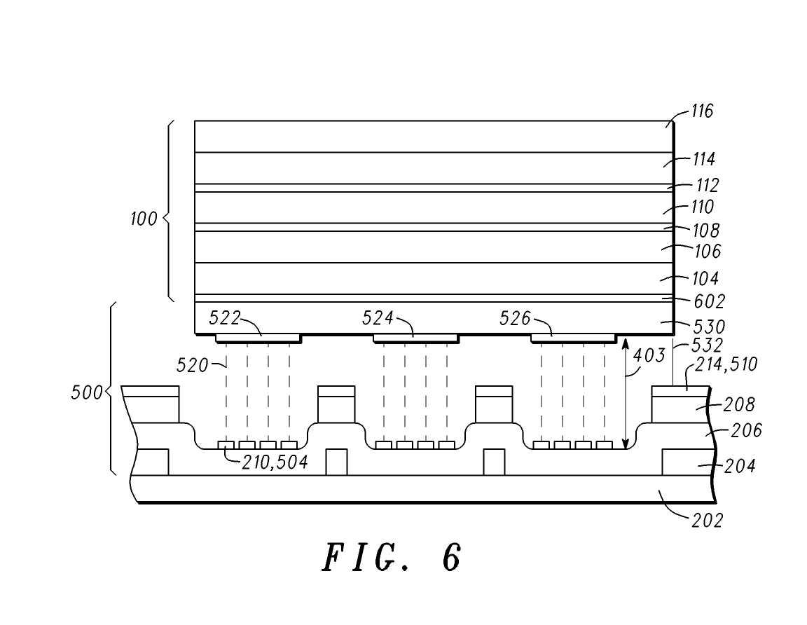

FIG. 6 is a partial cross section of the field emitter backlight 500 taken along line 6-6 of FIG. 5 and disposed beneath an LCD 100 in accordance with the exemplary embodiment. The LCD 100 includes, as similarly discussed with reference to FIG. 1, horizontal filter film 104, the substrate 106, the first electrode 108, the layer 110 of liquid crystal molecules, a second electrode 112, and a second substrate 114, and the vertical filter film 116. The back light 500 includes, as similarly discussed with reference to FIGS. 3 and 5, the substrate 202, cathode metal (column address lines) 204, 508, ballast resistive layer 206, dielectric layer 208, emitter pads 210, 504, gate electrode (row address lines) 214, 510, anode 530, spacer 532, and phosphors 522, 524, 526.

The strategy of keeping spacers a distance 2 S away from the electron stream creates areas where little or no light is generated from the anode near the spacer. An optional diffuser layer 602 positioned between the anode 530 and the LCD 100 improves the scattering effect of the light provided by the field emitter backlight 500. This diffuser disperses the light from the area containing the spacers, creating a uniform field of light. For backlights includes colored subpixels, a stronger diffuser can produce uniform screens of each color during color-sequential operation. The broad area nature of a field emission source requires less diffusing, so a more efficient diffuser can be used in a field emission backlight than in an LED backlight. In addition, it has typically been challenging to achieve excellent short-range uniformity in field emission displays. The diffuser has the added benefit of making typical FED short-range uniformity variations completely uniform.

In an exemplary high voltage field emission backlight for a large screen television, the anode voltage would range between 8 and 15 Kvolts. Most field emission displays operate with an anode field less than 7 volts per micrometer, and more typically less than 5 volts per micrometer. Thus, the spacing S used for these anode voltages ranges from greater than 1 millimeter to greater than 3 millimeter. This means that the spacer should be positioned further than 2 millimeter, and often up to 6 millimeter away from the emitters. This is quite feasible in backlights because the backlight sub-pixels can be much larger than the pixels in the optical shutter module itself. With such large pixels, it is possible to associate one spacer with a single color sub-pixel in the backlight. This contrast sharply to spacer arrangements in field emission displays where a spacer typically spans hundreds of sub-pixels. This allows for the use of clever designs to reduce the impact of the large spacer to emitter spacing.

Luminance variations in the backlight resulting from spacers spaced 2 S from the electron beam can be minimized with proper designs. For the case of rectangular subpixels, the spacers can be placed at the short ends of the rectangle to reduce the impact of lost emission area. Several example designs include:
1) Assign spacers to only one of the colored phosphors in the device; for example, spacers only reside in the blue pixel 526 (see FIG. 5). Spacers are not needed at every blue pixel 526, but to create spatially uniform field of blue across the display, every blue subpixel 526 will need to have a reduced size for uniformity. The color balance between the phosphors is then easy to balance. In the case of the spacers at the blue phosphor, this is accomplished either by a) increasing the percentage of display area containing blue phosphor relative to the other colors (larger blue area on the anode compared to other colors), or b) excite the blue phosphor with relatively more electrons than the other colors (produce more electrons using a higher extraction potential), or increase the blue frame time in the color sequential scheme relative to the other colors. Often the blue subpixel is a good choice for spacers because, while blue phosphors are less efficient, the eye is more sensitive to blue.
2) Assign spacers to one color, but only reduce the phosphor size where the spacer is placed. This embodiment improves efficiency. In order to provide a uniform field of light with a diffuser, the brightness at the small pixels would be electronically compensated for reduced brightness by driving the pixels at the spacers harder (higher extraction potential) or longer than the others (pulse width modulation). Using a higher extraction potential is preferred because the pulse width method is not as efficient. Different extraction potentials can be provided by using column drivers or row scanning drivers which have some amplitude modulation or offset modulation capability.
3) Assign spacers across many colors (wider spacer than shown above). Electronically compensate for reduced brightness by driving the pixels at the spacers harder (higher extraction potential) or longer than the others (pulse width modulation). For example, the spacer could traverse all three colors, so no additional color balancing would be needed.
4) Assign spacers to one color, and periodically remove that color across the array for uniformity. To re-gain lost brightness for that color relative to the others, reduce the width of the other phosphor regions, and increase the width of the phosphor corresponding to the spacer. This makes the overall light output similar.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A display comprising:
a backlight comprising:
an anode;
a cathode;
a plurality of electron emitters disposed on the cathode; and
a plurality of spacers positioned between the anode and cathode to separate the anode from the cathode by a first distance and disposed from the nearest electron emitters a second distance, wherein the second distance is at least twice the magnitude of the first distance; and
a plurality of optical shutters disposed to receive light from the backlight.

2. The display of claim 1 further comprising a diffuser layer disposed between the plurality of optical shutters and the backlight.

3. The display of claim 1 wherein the anode is capable of receiving a voltage of greater than 5,000 volts.

4. The display of claim 1 wherein the first distance is greater than 1 millimeter.

5. The display of claim 1 wherein the plurality of optical shutters is a liquid crystal display.

6. The display of claim 1 wherein each of the plurality of emitters are capable of being uniquely selected with sub-millisecond response times.

7. The display of claim 1 wherein the anode comprises a plurality of pixels, each pixel including a plurality of sub-pixels, each sub-pixel comprising one of a first, second, and third color phosphor, the spacers being positioned adjacent to sub-pixels of only one of the first, second, or third color phosphor.

8. The display of claim 7 wherein each of the plurality of pixels are capable of being uniquely addressed.

9. The display of claim 7 wherein the light output of at least one sub-pixel is electronically compensated to produce a more uniform field of light.

10. The display of claim 1 wherein the anode comprises a plurality of phosphors and each of the phosphors comprise one of a plurality of colors, wherein each one of the plurality of colors are capable of being sequentially addressed.

11. The display of claim 10 wherein the phosphors comprises a plurality of sizes to provide a uniform output.

12. A display comprising:
a liquid crystal display;
a field effect emitter disposed to provide backlight to the liquid crystal display, the field effect emitter comprising:
an anode;
a cathode spaced a first distance from the anode;
a plurality of emitters disposed on the cathode; and
a plurality of spacers positioned between the anode and cathode and disposed from the nearest emitter a second distance at least twice that of the first distance.

13. The display of claim 12 further comprising a diffuser layer disposed between the liquid crystal display and the backlight.

14. The display of claim 12 wherein the first distance is greater than 1 millimeter.

15. The display of claim 12 wherein the anode comprises a plurality of pixels, each pixel including a plurality of sub-pixels, each sub-pixel comprising one of a first, second, and third color phosphor, the spacers being positioned adjacent to sub-pixels of only one color.

16. The display of claim 15 wherein the liquid crystal display comprises a plurality of shutters, wherein each of the plurality of shutters and each of the plurality of emitters are capable of being uniquely selected.

17. The display of claim 15 wherein the anode comprises a plurality of phosphors and each of the phosphors comprise one of a plurality of colors, wherein the unique selection comprises sequentially selecting a color.

18. The display of claim 15 wherein the light output of at least one sub-pixel is electronically compensated to produce a more uniform field of light.

19. The display of claim 15 wherein the phosphors comprises a plurality of sizes to provide a uniform output.

20. A display comprising:
an anode having a plurality of pixels of phosphorus pads positioned thereon, each pixel comprising a first color sub-pixel, a second color sub-pixel, and a third color sub-pixel;
a cathode having a plurality of emitter pads positioned thereon, each of the emitter pads aligned with one of the first, second, and third color sub-pixels;
a plurality of spacers providing a spacing of a first distance between the anode and cathode, and positioned from the nearest emitter pad at least a second distance at least twice that of the first distance; and
a liquid crystal display disposed contiguous to the anode, wherein light emitted from the phosphor pads, due to impact by electrons from the emitter pads, traverse through the liquid crystal display.
